(19) United States
(12) Patent Application Publication
(10) Pub. No.: US 2020/0247003 A1
(43) Pub. Date: Aug. 6, 2020

(54) METHODS AND SYSTEMS FOR THREE-DIMENSIONAL PRINTING OF CERAMIC FIBER COMPOSITE STRUCTURES

(71) Applicant: Siemens Aktiengesellschaft, München (DE)

(72) Inventor: Ramesh Subramanian, Oviedo, FL (US)

(21) Appl. No.: 15/770,003

(22) PCT Filed: Oct. 27, 2016
(86) PCT No.: PCT/US2016/059029

§ 371 Date: Apr. 20, 2018

Related U.S. Application Data
(60) Provisional application No. 62/247,458, filed on Oct. 28, 2015.

(51) Int. Cl. B28B 1/00; B33Y 10/00; B33Y 30/00; B28B 11/24

(52) U.S. Cl. CPC B28B 1/001; B28B 11/243; B33Y 30/00; B33Y 10/00

(57) ABSTRACT

There is disclosed herein processes and systems for forming fiber-reinforced ceramic composite structures which, contrary to conventional methods, directly deposit a ceramic fiber composite on a working surface. The processes and systems enable the printing of ceramic fiber composite structures having complex shapes and allow for multiple fiber-matrix material combinations—so far not possible with conventional approaches. In addition, the systems and process described herein enable the printing of ceramic fiber composites on complex 3D surfaces, such as gas turbine components.

### CROSS-REFERENCE TO RELATED APPLICATIONS

This application claims priority and the benefit of the filing date of U.S. Provisional Application No. 62/247,458, filed Oct. 28, 2015, the entirety of which is hereby incorporated by reference.

### FIELD

The present invention relates to systems and processes for manufacturing components. More specifically, aspects of the present invention relate to methods and systems for the three-dimensional (3D) printing of ceramic matrix composite (CMC) structures which, unlike conventional methods, deposit a ceramic (solid) fiber composite in a desired pattern to form a desired structure.

### BACKGROUND

Gas turbines comprise a casing or cylinder for housing a compressor section, a combustion section, and a turbine section. A supply of air is compressed in the compressor section and directed into the combustion section. The compressed air enters the combustion inlet and is mixed with fuel. The air/fuel mixture is then combusted to produce high temperature and high pressure gas. This working gas then travels past the combustor transition and into the turbine section of the turbine.

Generally, the turbine section comprises rows of vanes which direct the working gas to the airfoil portions of the turbine blades. The working gas travels through the turbine section, causing the turbine blades to rotate, thereby turning the rotor. The rotor is also attached to the compressor section, thereby turning the compressor and also an electrical generator for producing electricity. High efficiency of a combustion turbine is achieved by heating the gas flowing through the combustion section to as high a temperature as is practical. The hot gas, however, may degrade various metal turbine components, such as the combustor, transition ducts, vanes, ring segments, and turbine blades that it passes when flowing through the turbine.

For this reason, strategies have been developed to protect turbine components from extreme temperatures, such as the development and selection of high temperature materials adapted to withstand these extreme temperatures and cooling strategies to keep the components adequately cooled during operation. State of the art superalloys with additional protective coatings are commonly used for hot gas path components of gas turbines. In view of the substantial and longstanding development in the area of superalloys, however, it figures to be extremely difficult to further increase the temperature capability of superalloys.

For this reason, ceramic matrix composite (CMC) materials have been developed and increasingly utilized. These materials offer a high temperature resistance, e.g., up to or greater than 1200° C. Typically, CMC materials include a ceramic or a ceramic matrix material, either of which hosts a plurality of reinforcing fibers. The fibers may have a predetermined orientation to provide the CMC materials with additional mechanical strength. Generally, (fiber reinforced) ceramic matrix composites are manufactured by the infiltration of a matrix slurry (e.g., alumina, mullite, silicon-containing polymers, molten silicon) into a fiber preform. As such, the fibers are thus restricted to simple geometries with blunt curvatures as it is difficult to orient fibers at edges of the component into the complex shapes typical of gas turbine components. Also, for higher strength components, a three-dimensional weave structure in the preform may be required. Such weave structures are, however, difficult to infiltrate at high densities, thereby leaving pores as defects and crack initiators. Further, the weaving process itself may substantially weaken the fibers.

Three-dimensional printing techniques have been developed in order to deposit ceramic materials onto a previously deposited layer of a ceramic material. These 3D printing techniques for ceramic materials may be based on or include lithography, ultraviolet light, laser sintering, or binder jetting, free form extrusion, and the like. In many of these techniques, a binder is included and thereafter removed upon heating, thereby leaving a structurally poor ceramic material or a dense monolithic ceramic body. As such, these techniques do not allow for the deposition of advanced ceramic matrix composite structures with long fiber reinforcement.

### SUMMARY

In contrast to known approaches for forming ceramic matrix composite materials (wherein a ceramic or ceramic matrix material is introduced into a fibrous matrix or prepreg to form a ceramic matrix composite), aspects of the present invention enable a solid fiber material to be 3D-printed/co-extruded with a ceramic material (ceramic or ceramic matrix material). In certain aspects, a ceramic material is combined with a fiber material to form a ceramic fiber composite prior to 3D printing (depositing). The ceramic fiber composite may then be printed onto a working surface in as many layers as necessary and in a predetermined pattern to form a desired structure. The 3D printing of the ceramic fiber composite may be done before, after, or simultaneously with the printing of a ceramic material (without fiber loading) so as to produce the desired structures. Advantageously, the systems and processes described herein enable the 3D printing of ceramic fiber composites into components having complex shapes, and also enable the printing of ceramic fiber composites on complex 3D surfaces, such as gas turbine components. In this way, the systems and processes described herein allow for new compositions and the manufacture of components otherwise not yet considered at the present time. For example, components having distinct ceramic materials, fibers, and porosities within the same component are now much more accessible with aspects of the present invention. In addition, certain aspects of the present invention may eliminate the need for a coating deposition as a separate manufacturing step.

In accordance with one aspect of the present invention, there is provided a process for forming a ceramic fiber composite structure comprising: introducing a first ceramic material into a first solid fiber material to produce a first ceramic fiber composite; depositing the first ceramic fiber composite onto a working surface; and repeating the introducing and depositing steps until the structure is formed.

In accordance with another aspect, there is provided a process for manufacturing a ceramic fiber composite structure comprising: forming a first ceramic fiber composite; and sequentially forming a plurality of layers in a predetermined pattern corresponding to a desired shape of the structure, the sequentially forming comprising, for at least one layer, depositing the first ceramic fiber composite in accordance with the predetermined pattern.

In accordance with yet another aspect, there is provided an apparatus for forming a ceramic fiber composite structure comprising: a source of a first solid fiber material; a source of a first ceramic material; a first injector in fluid communication with the source of the first ceramic material and configured for introducing the first ceramic material into the first solid fiber material to provide a first ceramic fiber composite; and a first dispensing head configured to deposit the first ceramic fiber composite therefrom in a predetermined pattern.

### BRIEF DESCRIPTION OF THE DRAWINGS

The invention is explained in the following description in view of the drawings that show:

FIG. 1 is a schematic view of a 3D printing system for manufacturing a component from a ceramic matrix composite in accordance with an aspect of the present invention;

FIG. 2 is a cross-section of a fiber material comprising an uptake enhancement structure in accordance with an aspect of the present invention;

FIG. 3 is a schematic showing further components for a 3D printing system in accordance with an aspect of the present invention;

FIG. 4 illustrates a fiber material loaded with two ceramic materials in distinct portions thereof in accordance with an aspect of the present invention.

FIG. 5 illustrates a fiber material having a first and a second ceramic coating layer in accordance with an aspect of the present invention;

FIG. 6 is a schematic showing further components for a 3D printing system in accordance with an aspect of the present invention;

FIG. 7 is a schematic showing still further components for a 3D printing system in accordance with an aspect of the present invention;

FIG. 8 illustrates a cutting mechanism associated with a dispensing head in accordance with an aspect of the present invention;

FIG. 9 illustrates a stationary vane formed by a system in accordance with an aspect of the present invention;

FIG. 10 illustrates a dispensing head having a laser source attached thereto in accordance with an aspect of the present invention.

FIGS. 11-12 illustrate steps in a 3D printing process of a ceramic fiber composite in accordance with an aspect of the present invention;

FIG. 13 illustrates the printing and cutting of a ceramic fiber composite in a predetermined pattern in accordance with an aspect of the present invention;

FIG. 14 illustrates the printing and cutting of a ceramic fiber composite in a predetermined pattern in accordance with another aspect of the present invention;

FIG. 15 illustrates a printing pattern in accordance with an aspect of the present invention.

FIG. 16 illustrates a component of a ceramic matrix composite material having a defect therein.

FIG. 17 illustrates the repair of the defect of FIG. 16 via application of a ceramic fiber composite in accordance with aspects of the present invention.

FIG. 18 illustrates a robotic arm having a dispensing head associated therewith in accordance with an aspect of the present invention.

### DETAILED DESCRIPTION

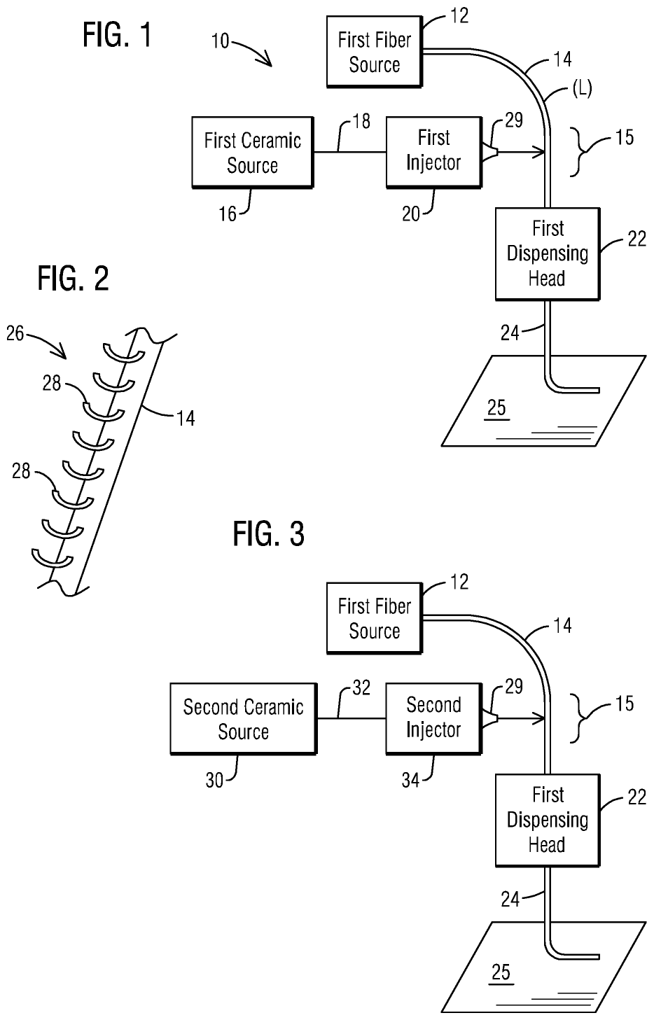

Referring now to the Figures, FIG. 1 illustrates a system 10 comprising a source 12 of a first solid fiber material 14 (or fiber material 14), a source 16 of a first ceramic material 18, a first injector 20 in fluid communication with the source 16 of the first ceramic material 18 configured to introduce an amount of the first ceramic material 18 into the first solid fiber material 14 to form a first ceramic fiber composite 24; and a first dispensing head 22 configured to deposit the first ceramic fiber composite 24 therefrom in a predetermined pattern onto a working surface 25. By way of example, the working surface 25 may be a substrate, a layer of ceramic material, or a previously deposited layer of a ceramic fiber composite. As used herein, the term “ceramic fiber composite” is understood to refer to a material formed from a combination, e.g., extrusion, of a ceramic or ceramic matrix material with a solid fiber material.

The source 12 of first solid fiber material 14 may be in any form such as a spool (with fibers wound about a mandrel) or the like which conveys an amount of the first ceramic fiber material 14 for the system 10 as needed. In addition, the first solid fiber material 14 may comprise any suitable fiber material which provides a degree of added strength for the ceramic fiber composite. The fiber material 14 also has a desired thickness and a longitudinal length (L), which may extend through at least a portion of the system 10.

In an embodiment, the first solid fiber material 14 comprises a ceramic material. Without limitation, exemplary ceramic materials include alumina, mullite, aluminosilicate, yttria alumina garnet, silicon carbide, silicon nitride, silicon carbon nitride, molydisicilicide, zirconium oxide, titanium oxide, combinations thereof, and the like. In an embodiment, the fiber material 14 comprises an oxide material. In a particular embodiment, the fiber material 14 comprises a non-oxide material, such as silicon carbide, and the infiltration ceramic slurry comprises a ceramic-polymer mixture. In another particular embodiment, the fiber material 14 may comprise ceramic fibers sold under the trademark Nextel, such as Nextel 610, and 720 fibers. In addition, the fiber material 14 may be in any suitable form, such as a straight filament, a bundle or a roving of multiple fibers, a braid, or a rope. In still other embodiments, the fiber material may comprise non-ceramic materials, including but not limited to carbon, glass, polymeric, metal, or any other suitable fiber materials.

In an embodiment, the first solid fiber material 14 is delivered from the fiber source 12 such that a longitudinal section (L) of the fiber is repeatedly exposed (e.g., a loading region 15) to the first injector 20 as one of the first solid fiber material 14 and the first injector 20 is advanced past the other. As needed, an amount of a first ceramic material 18 may be introduced into the fiber material 14 by the first injector 20, or alternatively by any other suitable method or device. In this way, the first ceramic material 18 may be absorbed by and/or coated on the fiber material 14 along all or a portion of its longitudinal length to provide a first ceramic fiber composite 24. The amount of first ceramic material 18 introduced may be any suitable amount, such as from about 1 to about 500 μL per millimeter of length (L) of the associated fiber material, e.g., fiber material 14. As used herein, the term “about” refers to an amount that is ±5% of the stated amount.

In addition, the ceramic material 18 may be introduced into the solid first fiber material 14 by any suitable process and in any suitable form, such as a slurry or the like, to form the first ceramic fiber composite 24. In certain embodiments, the amount of ceramic material introduced to the first ceramic solid fiber composite may be a predetermined volume (vol.) % of the fiber material 14, such as from 1-75 vol. %, and in a particular embodiment, from 20-50 vol. %.

In an embodiment, the first solid fiber material 14 may comprise an uptake enhancement feature 26 associated therewith to facilitate uptake of the first ceramic material 18. In an embodiment, referring to FIG. 2, the uptake enhancement feature 26 may comprise a physical structure which facilitates uptake of the first ceramic material 18 (or other material) into the first solid fiber material 14. For example, the uptake enhancement feature 26 may comprise a member selected from the group consisting of tubes, whiskers, flyfeet, and scoops associated with the fiber material 14. In the embodiment shown, there is illustrated a longitudinal portion of the first solid fiber material 14 having scoops 28 integrated therewith for enhancing uptake of the first ceramic material 18, or any other material. The uptake enhancement feature 26 may be associated with a surface of the first solid fiber material 14 or may be incorporated within the first solid fiber material 14 by any suitable method. In a certain embodiment, the first solid fiber material 14 may be manufactured with the uptake enhancement feature 26 incorporated therein.

The source 16 of the first ceramic material 18 may comprise any suitable housing, such as a vessel or a syringe with a plunger, for containing a quantity of the first ceramic material 18. Similar to the first solid fiber material 14, the first ceramic material 18 may comprise an oxide material or a non-oxide material. In an embodiment, the first ceramic material 18 comprises an oxide material, such as zirconium oxide, titanium oxide, aluminum oxide, mullite, combinations thereof, and the like. In another embodiment, the first ceramic material 18 comprises a non-oxide material, such as a carbide material (e.g., an SiC material). In yet another embodiment, the first ceramic material 18 may comprise a ceramic-polymer mixture. In yet another embodiment, the ceramic material 18 may comprise a silicon-containing polymer, which may also comprise an oxide or non-oxide material. In certain embodiments, the first ceramic material 18 may comprise a mixture of two or more ceramic materials. Additionally, in some embodiments, the first solid fiber material 14 and the first ceramic material 18 may be of the same oxide or non-oxide material (e.g., oxide/oxide or non-oxide/non-oxide) or different materials of the same type (e.g. oxide1/oxide2, non-oxide1/non-oxide2). In other embodiments, the first solid fiber material 14 and the first ceramic material 18 may be of different types (e.g., oxide/non-oxide).

In accordance with an aspect, the first injector 20 is in fluid communication with the source 16 of the first ceramic material 18 such that the injector 20 introduces the first ceramic material 18 to the first solid fiber material 14 in a loading region 15 thereof. The amount of first ceramic material 18 delivered to the first solid fiber material 14 is without limitation and may, for example, be an amount which fully saturates the first solid fiber material 14 as portions of the first solid fiber material 14 travel past the first injector 20. In an embodiment, the amount of the first ceramic material 18 delivered to the first solid fiber material 18 by the first injector 20 may be from 1 to 500 μL per millimeter of length (L) of the fiber material, e.g., fiber material 18. Further, in an embodiment, the first ceramic material 16 has a solids fraction of from about 1 to about 90 wt %.

The skilled artisan would also readily appreciate that the amount of ceramic material 18 introduced to the first solid fiber material 14 may be dependent on properties of the first solid fiber material 14 and the first ceramic material 18, such as density, fiber thickness, viscosity, and the like. The first injector 20 may comprise any suitable structure that will allow for the active or passive introduction of a ceramic material, e.g., a first ceramic material 18, into an associated fiber material, e.g., first solid fiber material 14. In an embodiment, the first injector 20 comprises one or more nozzles 29, each of which may have any suitable outlet diameter and outlet shape suitable for the particular application. Further, in an embodiment, the first injector 20 may comprise a syringe comprising a suitable housing for storing an amount of a ceramic material therein, at least one nozzle 29, and a plunger for directing the ceramic material out of the syringe through the nozzle 29. The first injector 20 may further comprise any suitable valves, lines, pumps, or other components associated therewith as are necessary for operation thereof.

In accordance with an aspect, the first injector 20 may be disposed at any suitable angle relative to a longitudinal length (L) of the first solid fiber material 14 in order to introduce the first ceramic material 18 into the first solid fiber material 14 in the loading region 15 thereof to provide the ceramic fiber composite 24. In an embodiment, the angle is normal to the longitudinal length (L) of the first solid fiber material 14 as shown in FIG. 1, although it is understood that the present disclosure is not so limited. In other embodiments, the first injector 20 may be oriented at an angle other than 90 degrees relative to the longitudinal length (L) of the first solid fiber material 14.

As would further be appreciated by the skilled artisan, the above embodiment describes a single ceramic material being introduced to the first solid fiber material 14. It is understood, however, that the present invention is not so limited. In other embodiments, the system 10 may include one or more additional ceramic sources in communication with first injector 20 and/or one or more additional injectors for introducing the additional ceramic material(s) into the first solid fiber material 14. Referring to FIG. 3, for example, there is shown a source 30 of a second ceramic material 32 in fluid communication with a second injector 34, which may also include one or more nozzles 29 through which the second ceramic material 32 can exit. In this embodiment, the second injector 34 may configured to introduce a selected amount of the second ceramic material 32 into the first solid fiber material 14 in a loading region 15 thereof. The loading region 15 may progress up (toward the fiber source) as the first ceramic fiber composite 24 is deposited by the system 100. The first ceramic fiber composite 24 (though now loaded instead or also with a second ceramic material vs. a first ceramic material) may be deposited from the first dispensing head 22 onto the working surface 25. For ease of illustration, all of the components of FIG. 1 are not shown as being included in FIG. 3; however, it is understood that the components of FIG. 1 not shown may also be present in the embodiment shown in FIG. 3.

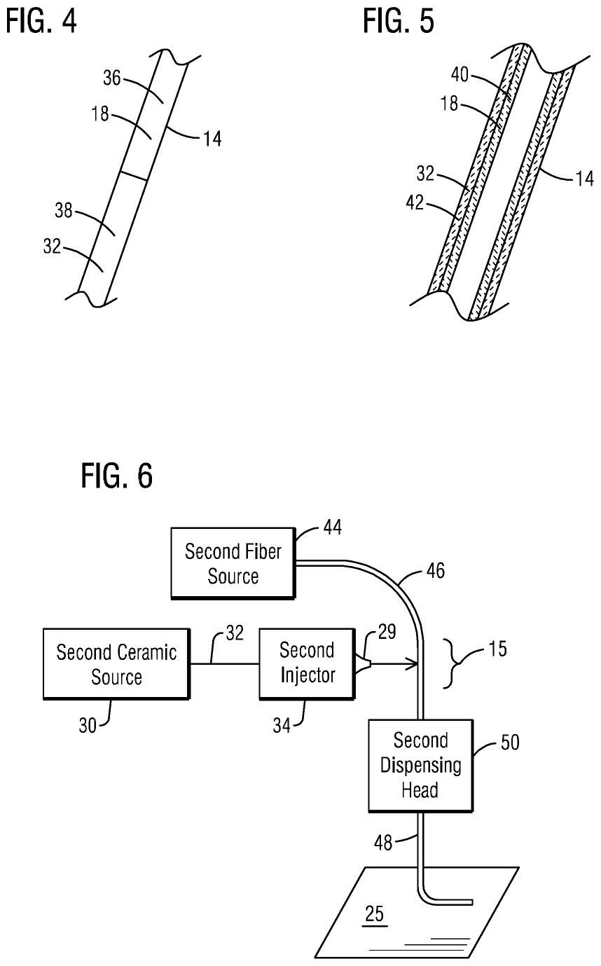

In an embodiment, as shown in FIG. 4, the second ceramic material 32 may be introduced to the first solid fiber material 14 such that a first longitudinal portion 36 of the first solid fiber material 14 has the first ceramic material 18 and a second (distinct) longitudinal portion 38 of the first solid fiber material 14 includes the second ceramic material 32. A line is shown dividing the two portions; however, it is understood that the separation of the two ceramic materials may not be so distinct, and that there may be some mixing of materials at or near the intersection of the two materials. Alternatively, a first length of the fiber material 14 could be provided with the first ceramic material 18, the first length cut (as will be described below), and a second length of the fiber material 14 could be provided with the second ceramic material 32. In this way, the first solid fiber material 18 and resulting ceramic matrix composite may be provided with more than one type of ceramic material, such as ceramic materials having differing porosities. This may be useful, for example, when higher temperature fibers are more desirable in a portion of the component vs. another portion. Aspects of the present invention thus provide numerous design options in the formation of ceramic fiber composite materials.

In still other embodiments, as shown in FIG. 5, the second ceramic material 32 may be added to the first solid fiber material 14 in a same region 15 of the first solid fiber material 14 such that the first ceramic material 18 forms a first ceramic layer 40 on the fiber material 14 and the second ceramic material 32 forms a second ceramic layer 42 over the first ceramic layer 40. FIG. 5 is a cross-sectional view of a portion of a fiber (fiber material 14) having a first ceramic layer 40 and a second ceramic layer 42 thereover. In this embodiment, the second ceramic material 32 may be different from that of the first ceramic material 18 in terms of composition, porosity, or the like. In this way, in certain embodiments, the first solid fiber material 14 may be provided with the beneficial properties of two distinct ceramic materials.

In other embodiments, one or more ceramic materials may be mixed by a suitable mixing device and introduced into the first solid fiber material 14 by the first injector 20, the second injector 34, or a like device. In this way also, novel materials may further be created, such as a fiber material loaded into a ceramic blend having desired properties from each of a plurality of distinct ceramic materials, or having new properties altogether.

In accordance with another aspect, the system 10 allows for more than one type of fiber material to be deposited therefrom. To accomplish this, in an embodiment (and referring now to FIG. 6), the system 10 may further include a source 44 of a second solid fiber material 46, a second injector 34 in communication with the source 30 of a second ceramic material 32 (as previously described herein), the second injector 34 configured for introducing the second ceramic material 32 into the second solid fiber material 46 in a loading region 15 thereof to produce a second ceramic fiber composite 48. In addition, the system 10 may further describe a second dispensing head 50 for dispensing the second ceramic fiber composite 48 onto the working surface 25 (which may be a substrate, a previously laid down layer of a ceramic material, first ceramic fiber composite 24, or a second ceramic fiber composite 48) in a predetermined pattern. Again, for ease of illustration, the other components described herein for system 10 are not shown in FIG. 6, but it is understood that they may be included therein.

Further, for ease of discussion, the source 44 of second solid fiber material 46, the second solid fiber material 46, the second ceramic fiber composite 48, the source of second ceramic material 30, the second ceramic material 32, the second injector 34, and the second dispensing head 50 may be the same or similar in structure or composition as described above for the corresponding first ones of each component (12, 14, 16, 18, 20, 22, 24). It is understood in the interest of brevity the possible embodiments for each composition will not be re-explained. It is further understood that each component may be of the same structure/type as that of its corresponding first component, or may be different in kind. By way of example only, the second solid fiber material 46 may be different from the first solid fiber material 14. Still further, it is further understood that the present invention is not so limited to first and second ones of the above components. In certain embodiments, still further fiber or ceramic materials (and corresponding components for the same) may be provided.

In accordance with another aspect, when the first ceramic fiber composite 24 or the second ceramic fiber composite 48 are printed (deposited), the first ceramic fiber composite 24 and the second ceramic fiber composite 48 may be deposited on or incorporated into an existing working surface 25 that comprises a ceramic material (the term “ceramic” is understood herein to include a ceramic or ceramic matrix material). In an embodiment, the working surface 25 comprises a ceramic material without fibers incorporated therein. In certain aspects, the system 10 may further include a structure for dispensing the ceramic material without fibers in a predetermined pattern. The ceramic fiber composite(s) may then be added onto/into the deposited ceramic only material. In this way, aspects of the present invention may not only print a ceramic fiber composite, but also add a fiber material to a ceramic material to build a component in contrast to known systems and process, wherein a ceramic material is incorporated into a fiber material, typically a fiber layup or preform.

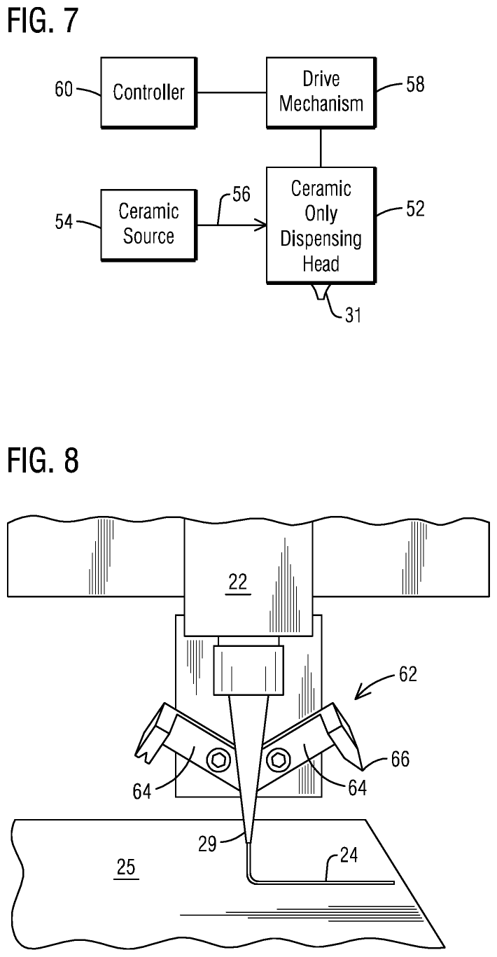

Referring now to FIG. 7, to provide a ceramic material to the working surface 25, the system 10 may further include a ceramic only dispensing head 52 in fluid communication with a source 54 of a ceramic material 56. As with dispensing heads 22, 50, the dispensing head 52 may include at least an inlet and an outlet, such as a nozzle 31, for dispensing of the ceramic material 56 therefrom. In addition, the source 54 of ceramic material 56 may be the same as the source of ceramic material (e.g., sources 16, 30) or may comprise an independent source of a ceramic material as shown. Thus, in an embodiment, the ceramic material 56 may comprise either or both of the first ceramic material 18 and the second ceramic material 32.

As will be discussed below, in certain embodiments, the ceramic only dispensing head 52 may deposit the ceramic material 56 in a predetermined pattern in one or more layers on the working surface 25. Thereafter, an amount of a first or second ceramic fiber composite 24, 48 may be deposited on the ceramic material 56 (or vice-versa). Further thereafter, an additional layer of ceramic material 56 or a ceramic fiber composite material (e.g., 22, 48) may be deposited on the previously deposited layer(s) in a predetermined pattern. These steps may be repeated in any desired order until the component is formed. It is appreciated that any desired number of fiber dispensing heads or ceramic only dispensing heads may be provided in the system 10 or as modules to be added/removed from existing systems.

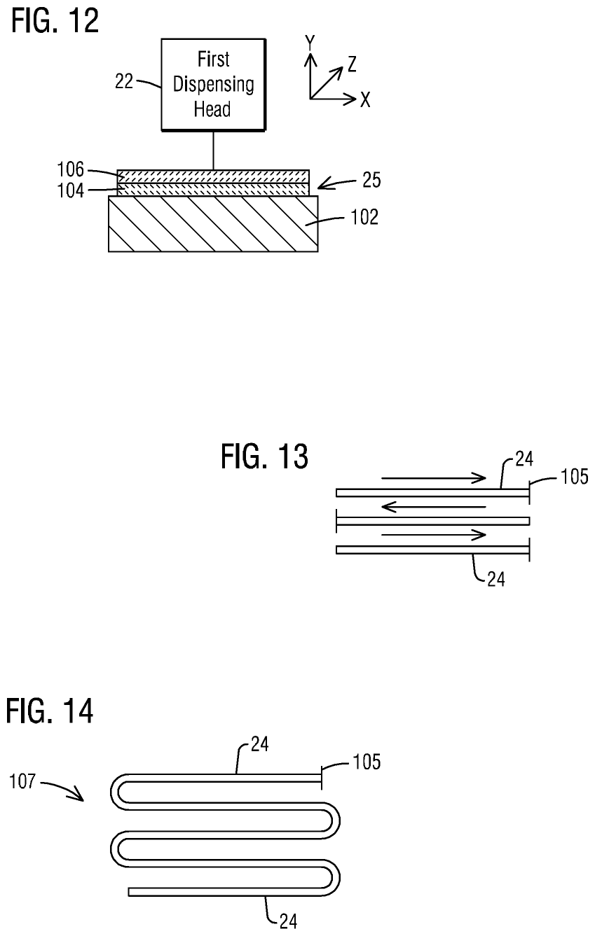

In accordance with another aspect, as mentioned, the dispensing heads (e.g., 22, 50, or 52) deposit the ceramic fiber composites or the ceramic material in a predetermined pattern. To accomplish this, a motor or other drive mechanism 58 may be associated with each dispensing head (e.g., 22, 50, or 52) to allow for deposition of the associated material on the working surface 25 in any coordinate position at a point in time. In an embodiment, the working surface 25 is configured to move with respect to the dispensing heads (e.g., 22, 50, and/or 52). In another embodiment, the dispensing heads (e.g., 22, 50, and/or 52) may be configured to move with respect to the working surface 25. In certain embodiments, as shown in FIG. 18, the drive mechanism 58 comprises a robotic arm 75, and any of the dispensing heads described herein (e.g., head 22) may be associated with the robotic arm 75 such that the associated dispensing heads have a freedom of movement in any desired direction (e.g., rotationally and in any or all of an x, y, or z direction (FIG. 12). Without limitation, the robotic arm 75 may comprise a 5-axis or a 6-axis robotic arm as are known in the art.

In addition, the system 10 may further comprise one or more controllers (e.g., controller 60) in electrical (wired or wireless) in communication with the drive mechanism 58 to facilitate the amounts, concentrations, order, location of, and extent of deposition of the materials, as well as the operation of any pumps, values, or the like, positions of the working surface 25 and/or dispensing heads 22, 50, or 52, or other parameter(s). For purposes of illustration, FIG. 7 shows a controller 60 in electrical communication with a drive mechanism 58 for controlling a position of the ceramic only dispensing head 52, although it is understood the remaining dispensing heads (e.g., heads 22, 50) may have the same or a distinct drive mechanism 58 and/or controller 60 associated therewith.

The controller 60 may comprise a general or special purpose computer programmed with or software/hardware to carry out an intended function as described herein. As used herein, the term “computer” may include a processor, a microcontroller, a microcomputer, a programmable logic controller (PLC), a discrete logic circuit, an application specific integrated circuit, or any suitable programmable circuit or controlling device. The memory may include a computer-readable medium or a storage device, e.g., floppy disk, a compact disc read only memory (CD-ROM), or the like. In an embodiment, the controller 60 executes computer readable instructions for performing any aspect of the methods or for controlling any aspect of the systems or process steps described herein. As such, the controller 60 may be configured to execute computer readable instructions to monitor and/or adjust parameters such as: timing of deposition steps, the amounts, concentrations, order, location of, and extent of deposition of materials; the operation of pumps, valves, or the like; positions of the working surface and/or dispensing heads, or any other parameter(s). If necessary, the systems and processes described herein may employ one or more sensors for monitoring a desired parameter. Correspondingly, the controller 60 may comprise one or more inputs for receiving information from the one or more sensors.

In accordance with another aspect, when the first ceramic fiber composite 24, the second ceramic fiber composite 48, fiber material alone, or an additional fiber material is deposited onto the working surface 25, these components (which include a fiber material) may need to be cut, such as at an edge of the predetermined pattern. To accomplish this, as shown in FIG. 8, the system 10 may further include a cutting mechanism 62 to cut the fiber material (e.g., first or second ceramic fiber composite 24, 48) at a point of time after deposition of the ceramic fiber composite from its associated dispensing head, e.g., head 22 as shown. In certain embodiments, the cutting mechanism 62 may be associated with a particular (fiber) dispensing head (e.g., one of heads 22, 50) so as to be able to cut the ceramic fiber composite close to the outlet of the nozzle 29 where it is deposited so as to leave little slack after cutting.

The cutting mechanism 62 may comprise any suitable component effective to cut the desired material at a desired time and location. In an embodiment, the cutting mechanism 62 comprises a device that cuts the fiber material mechanically. Without limitation, as shown in FIG. 8, the cutting mechanism 62 may comprise two opposable arms 64, one or both housing a cutting tool 66, such as a cutting (razor) blade, which acts to cut the ceramic fiber composite upon closure of the arms 64 with respect to one another (with the fiber material therebetween). Alternatively, the cutting mechanism 62 may comprise any other structure configured to cut the fiber material deposited from an associated dispensing head at a predetermined time and position on the ceramic fiber composite (e.g., 24 or 48). The cutting mechanism 62 may also include a laser-based approach. For example, as shown in FIG. 10, the cutting mechanism 62 may also comprise a laser source 65, which may be (but not necessarily) associated with a particular dispensing head (e.g., 22 or 50) and which is configured to deliver a suitable amount of energy 67 for cutting the ceramic fiber composite (e.g., 24 or 48) at a desired position.

In particular embodiments, activation of the cutting mechanism 62 may be automated, and thus programmed to cut the associated fiber material when the associated dispensing head or working surface 25 reaches a desired location/position or at a predetermined point in time. The cutting mechanism 62 may itself have a controller/microprocessor (of the type described above for controller 60) for automating these functions, or alternatively may be in electrical communication with an external controller, e.g., controller 60, for control of the operation thereof.

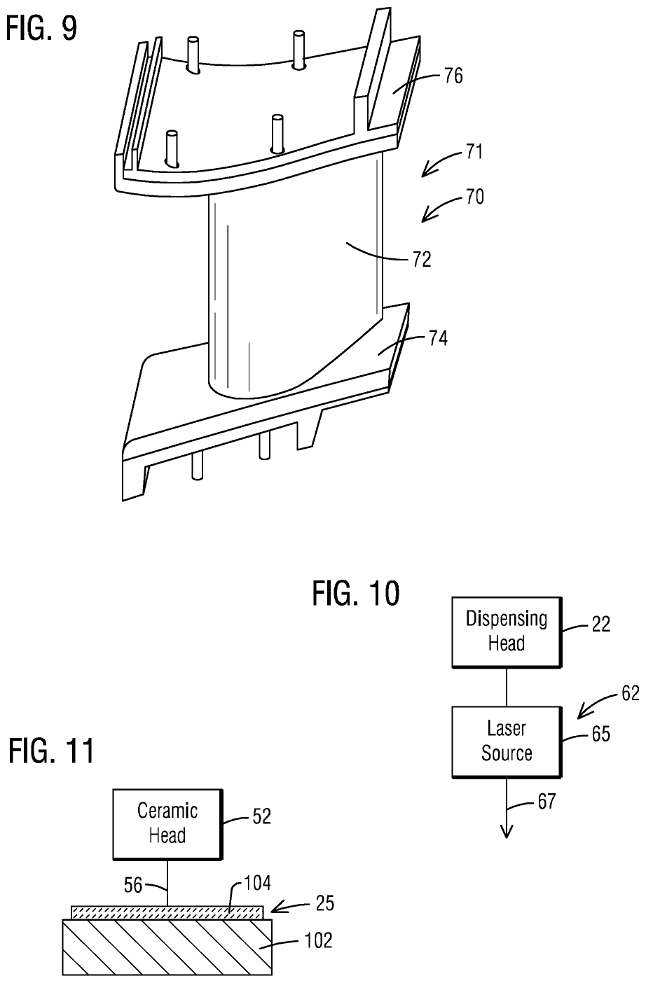

The apparatuses and products described herein may be suitable for manufacturing any ceramic matrix composite structures. The structure may be a newly manufactured component or a repair or addition to an existing component. In an aspect of the invention, the apparatuses and processes described herein are suitable for the manufacture of components having a complex 3D shape, e.g., an airfoil, shape. Thus, in an embodiment, the structure formed by the systems and processes described herein may comprise a gas turbine component. In certain embodiments, the gas turbine component may comprise a rotating component, such as a blade. In other embodiments, the gas turbine component may comprise a stationary component, such as a vane. By way of example, FIG. 9 illustrates a component 70, e.g., a stationary vane 71, having an airfoil portion 72 of a ceramic fiber composite formed by any of the processes and systems described herein. As shown, the airfoil portion 72 may be disposed between an inner and outer platform 74, 76, and secured to each by any suitable method or structure to provide the stationary vane 71.

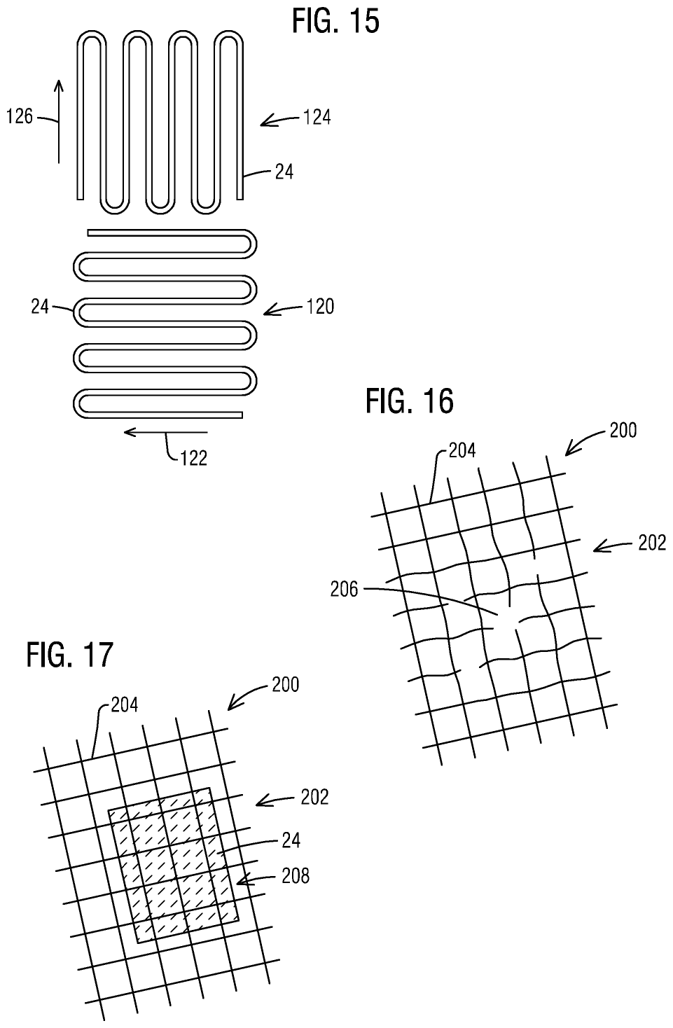

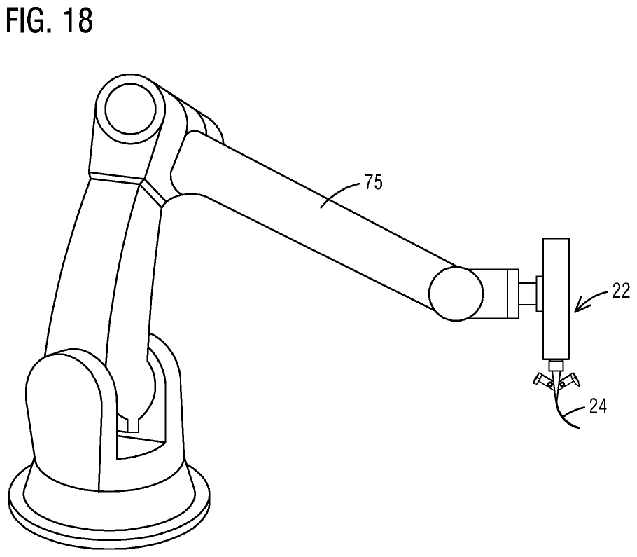

In other embodiments, the systems and processes may be configured for 3D printing the material to repair/augment an existing component, such as any of the gas turbine components described herein. By way of example, FIG. 16 illustrates a portion of an existing component 200 formed from a typical ceramic matrix composite 202. In this embodiment, as is typical for high strength components, the ceramic matrix composite 202 may comprise a fibrous layup or weave 204 into which a ceramic or ceramic matrix material is impregnated. For ease of illustration, the ceramic material is considered to be removed from FIGS. 16-17. When the component 200 is damaged through operation and include one or more defects 206 formed therein, it of course may be desirable to repair the defect(s) 206 to restore it to a desirable operating condition. In the case of the weave 204 shown in FIG. 16, however, it is well-appreciated that restoration of the original weave structure may be completely impossible as the weave structure cannot be recreated at the location of the defect(s) 206. Current known systems and methods do not provide an adequate method of repairing ceramic matrix composite structures where the weave structure has been compromised. Aspects of the present invention, however, provide a system and method for providing localized ceramic-reinforced fibers where necessary to repair the defect. As shown in FIG. 17, where the defect(s) 206 lie in the fibrous weave 204, a ceramic solid fiber composite, e.g., first ceramic fiber composite 24, can be printed within the area of the defect(s) 206 via any system or process described herein so as to reestablish a fiber reinforced ceramic (repair 208) with a comparable, if not stronger, ceramic (solid) fiber composite at the location of the defect(s) 206.

The operation of the systems as described herein, and the components therein, will be briefly described in the below paragraphs. It is however understood that the processes for operating the systems described herein and manufacturing component(s) therefrom is not so limited to the below description. Accordingly, the processes may include any additional or alternative steps that would be appreciated from the disclosure of the components described herein. Further, any component(s) or process step(s) described herein with respect to one embodiment may be combined with component(s) or process step(s) of any other embodiment described herein.

Referring now to FIGS. 11-12, there are shown exemplary steps in a process for forming a ceramic matrix composite component in accordance with an aspect of the present invention. As shown in FIG. 11, an amount of a ceramic material 56 is first delivered from the ceramic only dispensing head 52 onto a substrate 102 to form a first (cross-sectional) layer 104 thereon (working surface 25). The substrate 102 may comprise any suitable structure. In certain embodiments, the substrate 102 may comprise a platform for a blade or vane, a substrate intended to be removed upon completion of the component, or alternatively may be an initial cross-section of the component to be formed. In an embodiment, a ceramic material 56 may be deposited on the substrate 102 by the ceramic only dispensing head 52 in a predetermined pattern to form the first layer 104.

Next, as shown in FIG. 12, an additional ceramic layer may be deposited from dispensing head 52, or a layer of a ceramic fiber composite (e.g., 24 or 48) may be deposited from an associated dispensing head (22 or 50) onto the first layer 104 to form the next cross-sectional layer 106 and an updated working surface 25. Alternatively, one or more ceramic fiber composite layers may be first deposited on the substrate 102, and thereafter layer(s) of a ceramic material, e.g., ceramic material 56, may be deposited thereon.

To accomplish the deposition of the ceramic fiber composite, as was shown in FIGS. 1 and 3, a suitable amount of a fiber material, e.g., first solid fiber material 14, may be deposited from its corresponding fiber material source, e.g., source 16. An amount of a ceramic material (e.g., first or second ceramic materials 18, 32) may be introduced onto/into the fiber material 14 from a corresponding injector (e.g., injector 20 or 34). The resulting ceramic fiber composite (e.g., 24 or 48) may be fed to a corresponding dispensing head (e.g., 22 or 50).

To deposit the ceramic fiber composite(s) (24 or 48) onto the working surface 25 in the predetermined pattern, the associated dispensing head (e.g., 22, 50) may deposit the desired material and be moved with respect to the working surface 25 in any direction as shown in FIG. 11, or alternatively, the working surface 25 may be caused to move in any of the direction with respect to the associated dispensing head (e.g., 22, 50). In any case, the ceramic fiber composite (e.g., 24 or 48) may be deposited from its associated dispensing head (e.g., 22 or 50) so as to deposit the ceramic fiber composite (e.g., 24 or 48) onto the working surface 25 in a predetermined pattern to form the next cross-sectional layer 106.

Thereafter, an additional ceramic only layer or an additional ceramic fiber composite layer may be deposited on the next cross-sectional layer 106 to form a yet further cross-sectional layer. It is appreciated that this process may be repeated several times until the desired structure is formed. Still further, the combination of ceramic materials, fiber materials, ceramic fiber composites, and order of printing (deposition) of components may be quite large in number and is without limitation herein. In certain embodiments even, the fiber material may be deposited on the working surface 25 without loading of a ceramic material therein.

As noted above, when a fiber material as described herein (ceramic fiber composite or fiber material without ceramic material) is deposited, it may be desirable to cut the fiber material at a point in its path of deposition. Referring again to FIGS. 8 and 10, the deposited fiber material, e.g., 24 or 48, may be cut at a desired position along a longitudinal length thereof by the cutting mechanism 62, which may be mechanical or laser-based. For example, as shown in FIG. 13, the ceramic fiber composite (e.g., first ceramic fiber composite 24) may be cut upon reaching an edge of the component to be formed as indicated by the solid lines 105. The solid lines 105 refer to locations where a cut may be made. The arrows in this instance refer to the direction of deposition of the material. Spacing between deposited tracks is illustrated in FIG. 13 to better show the path of deposition; however, it is appreciated that the spacing between tracks is not necessary or may not be desired. Typically, an overlap is desired of approximately 10-20% of the roving diameter when the fiber material is in the form of a roving.

In accordance with another aspect, as shown in FIG. 14, the systems and processes described herein may allow for turning of the fiber material (e.g., ceramic fiber composite 24) as indicated by reference numeral 107 without cutting of the material. In certain embodiments, the fiber material is not cut until deposition of the subject cross-sectional layer is complete as is indicated by solid line 105. The skilled artisan would readily appreciate whether turning of the fibers would be suitable for a particular application may be dependent on fiber thickness, fiber stiffness, the length of the deposition path, degree of turn, and the like. Moreover, to reiterate, spacing between deposited tracks is illustrated in FIG. 14 to better show the path of deposition; however, it is appreciated that the spacing between tracks (or turns) is not necessary or may not be desired.

When ceramic fiber composites are printed as described herein, the cutting step allows complex geometries to be formed as the component's shape is not limited to an existing preform fiber shape. In accordance with another aspect, the deposition of the materials described herein can be provided in any desired order layer by layer until the component having a final desired composition, shape, and size is formed. Nothing in this disclosure is intended to limit the order of deposition of layers herein, each of which may comprise any of the material(s) described herein.

It is further contemplated that the deposited materials need not all be printed/deposited in the same direction and pattern. In accordance with another aspect, it is contemplated that a “weave-like” structure may be formed by depositing a first layer of the loaded ceramic material in a first x, y, or z direction and thereafter 3D printing a second layer over the first layer in a second x, y, or z direction distinct from the first direction. For example, as shown in FIG. 15, a first layer 120 of a fiber loaded ceramic material (e.g. 24 or 48) may be printed in at least a first direction 122 and a second layer 124 of the fiber loaded ceramic material (e.g. 24 or 48) may be printed in at least a second direction 126, e.g. transverse to the first direction 122.

In the manufacture of a typical ceramic matrix composite material, a fiber preform is utilized which includes a weave structure, wherein fibers extending in one direction are loomed over and under fibers extending in another direction (e.g., transversely) to add strength to the overall material. In an aspect, the 3D printing of ceramic fiber composite material(s) as described herein improves upon these conventional techniques. As mentioned above, the weaving process may, in fact, significantly weaken the mechanical strength of the fibers. In contrast, the systems and processes described herein allow fibers to be oriented in different directions in the same material yet alleviate weakening of the fibers caused by typical weaving processes.

In accordance with another aspect, once all the desired layers are deposited to form the component 70 as described in any of the systems and processes described herein, the component 70 may be sintered or otherwise heated to a desired temperature. The sintering, for example, may take place by the application of energy, such as the application of heat, for any suitable duration at any desired temperature. In an embodiment, the component 70 (upon printing of all the layers) is sintered at a temperature of at least about 500° C., and in particular embodiment from 500° C. to 1200° C.—either isothermally or with a temperature gradient.

In accordance with an aspect, any existing system configured for the free form extrusion of ceramic materials can be modified with the components described herein to provide a system which deposits a ceramic fiber composite as described herein. Further, although aspects of the present invention have been explained in the context of manufacturing or repairing gas turbine components, as easily understood by those skilled in the art, the instant manufacturing concepts may be applied to other suitable fields and components.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

1-44. (canceled)

45. A process for forming a ceramic fiber composite structure comprising:
injecting a ceramic material into a solid fiber material via an injector into a loading region of the solid fiber material to produce a ceramic fiber composite in the loading region, wherein the loading region defines only a portion of the longitudinal length of the solid fiber material;
depositing the ceramic fiber composite in a predetermined pattern on a working surface to form the structure;
repeating the injecting and depositing steps until the structure is formed;
wherein the loading region is advanced along the longitudinal length of the solid fiber material as the ceramic matrix composite is deposited on the working surface.

46. The process of claim 45, further comprising dispensing an amount of a solid fiber material from a spool of the solid fiber material.

47. The process of claim 45, wherein the working surface comprises a previously deposited layer of the ceramic fiber composite.

48. The process of claim 45, further comprising depositing a layer of a ceramic material without fibers onto the working surface such that the working surface comprises a ceramic material without a fiber material therein.

49. The process of claim 45, wherein the solid fiber material comprises an oxide material, and wherein the ceramic material comprises an oxide material.

50. The process of claim 45, further comprising:
injecting a second ceramic material into a second solid fiber material to produce a second ceramic fiber composite; and
depositing the second ceramic fiber composite onto the working surface.

51. The process of claim 50, wherein the ceramic material comprises a first ceramic material, and wherein the first ceramic material and the second ceramic material are distinct materials.

52. The process of claim 45, wherein a first layer of the ceramic fiber composite is deposited in a first x, y, or z direction and a second layer of the ceramic fiber composite is deposited in a second x, y, or z direction distinct from the first x, y, or z direction.

53. The process of claim 45, further comprising introducing a second ceramic material into the solid fiber material.

54. The process of claim 45, wherein the injecting is done at an angle normal to a longitudinal length of the solid fiber material.

55. The process of claim 45, further comprising cutting the ceramic fiber composite during the depositing of the ceramic fiber composite.

56. The process of claim 45, further comprising sintering the formed structure.

57. The process of claim 45, wherein the solid fiber material is in a form selected from a braid, a roving with multiple fibers, and a rope.

58. The process of claim 45, wherein the solid fiber material comprises an uptake enhancement feature associated therewith selected from the group consisting of tubes, whiskers, flyfeet, and scoops.

59. The process of claim 45, wherein the working surface comprises an existing ceramic matrix composite layup.

60. The process of claim 45, wherein the solid fiber material comprises a ceramic fiber material.

61. The process of claim 45, wherein the ceramic mixture comprises a mixture of ceramic materials.

62. The process of claim 45, wherein the structure formed comprises a gas turbine component.

63. The process of claim 45, wherein the structure formed comprises a repair to an existing component.

64. A system for forming a ceramic fiber composite structure comprising:
a source of a solid fiber material;
a source of a ceramic material;
an injector in fluid communication with the source of the ceramic material and arranged to introduce the ceramic material into a loading region of the solid fiber material along a longitudinal length of the solid fiber material to produce a ceramic fiber composite, wherein the loading region defines only a portion of the longitudinal length of the solid fiber material; and
a dispensing head configured to deposit the first ceramic fiber composite therefrom in a predetermined pattern.

65. The system of claim 64, wherein the solid fiber material further comprises an uptake enhancement feature selected from the group consisting of tubes, whiskers, flyfeet, and scoops associated with the first solid fiber material.
